(19) United States
(12) Patent Application Publication
(10) Pub. No.: US 2026/0059503 A1
(43) Pub. Date: Feb. 26, 2026

(54) TRACKING REFERENCE SIGNALS IN OVERLAPPING TIME RESOURCES

(71) Applicant: QUALCOMM INCORPORATED, San Diego, CA (US)

(72) Inventors: Min HUANG, Beijing (CN); Jing DAI, Beijing (CN); Hao XU, Beijing (CN)

(21) Appl. No.: 19/102,560

(22) PCT Filed: Sep. 29, 2022
(86) PCT No.: PCT/CN2022/122395

§ 371 Date: Feb. 10, 2025

(51) Int. Cl. H04W 72/0446; H04L 5/00; H04W 72/20

(52) U.S. Cl. CPC H04W 72/0446; H04L 5/0048; H04W 72/20

(57) ABSTRACT

Various aspects of the present disclosure generally relate to wireless communication. In some aspects, a user equipment (UE) may receive an indication of a set of time-domain rotation coefficients associated with a set of transmission reception points (TRPs) through which the UE communicates with a network node. The UE may receive a set of reference signals (RSS) from the set of TRPs in overlapping time resources, the set of RSs having the set of time-domain rotation coefficients applied. The UE may transmit an indication of time-domain channel properties (TDCPs) associated with TRPs of the set of TRPs. Numerous other aspects are described.

### FIELD OF THE DISCLOSURE

Aspects of the present disclosure generally relate to wireless communication and to techniques and apparatuses for tracking reference signals in overlapping time resources.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving an indication of a set of time-domain rotation coefficients associated with a set of transmission reception points (TRPs) through which the UE communicates with a network node. The method may include receiving a set of reference signals (RSs) from the set of TRPs in overlapping time resources, the set of RSs having the set of time-domain rotation coefficients applied. The method may include transmitting an indication of time-domain channel properties (TDCPs) associated with TRPs of the set of TRPs.

Some aspects described herein relate to a method of wireless communication performed by a network node. The method may include transmitting an indication of a set of time-domain rotation coefficients associated with a set of TRPs through which a UE communicates with the network node. The method may include transmitting a set of RSs via the set of TRPs in overlapping time resources, the set of RSs having the set of time-domain rotation coefficients applied. The method may include receiving an indication of TDCPs associated with TRPs of the set of TRPs.

Some aspects described herein relate to a UE for wireless communication. The UE may include a memory and one or more processors coupled to the memory. The one or more processors may be configured to receive an indication of a set of time-domain rotation coefficients associated with a set of TRPs through which the UE communicates with a network node. The one or more processors may be configured to receive a set of RSs from the set of TRPs in overlapping time resources, the set of RSs having the set of time-domain rotation coefficients applied. The one or more processors may be configured to transmit an indication of TDCPs associated with TRPs of the set of TRPs.

Some aspects described herein relate to a network node for wireless communication. The network node may include a memory and one or more processors coupled to the memory. The one or more processors may be configured to transmit an indication of a set of time-domain rotation coefficients associated with a set of TRPs through which a UE communicates with the network node. The one or more processors may be configured to transmit a set of RSs via the set of TRPs in overlapping time resources, the set of RSs having the set of time-domain rotation coefficients applied. The one or more processors may be configured to receive an indication of TDCPs associated with TRPs of the set of TRPs.

Some aspects described herein relate to a non-transitory computer-readable medium that stores a set of instructions for wireless communication by a one or more instructions that, when executed by one or more processors of an apparatus. The set of instructions, when executed by one or more processors of the one or more instructions that, when executed by one or more processors of an apparatus, may cause the one or more instructions that, when executed by one or more processors of an apparatus to receive an indication of a set of time-domain rotation coefficients associated with a set of TRPs through which the UE communicates with a network node. The set of instructions, when executed by one or more processors of the one or more instructions that, when executed by one or more processors of an apparatus, may cause the one or more instructions that, when executed by one or more processors of an apparatus to receive a set of RSs from the set of TRPs in overlapping time resources, the set of RSs having the set of time-domain rotation coefficients applied. The set of instructions, when executed by one or more processors of the one or more instructions that, when executed by one or more processors of an apparatus, may cause the one or more instructions that, when executed by one or more processors of an apparatus to transmit an indication of TDCPs associated with TRPs of the set of TRPs.

Some aspects described herein relate to a non-transitory computer-readable medium that stores a set of instructions for wireless communication by a network node. The set of instructions, when executed by one or more processors of the network node, may cause the network node to transmit an indication of a set of time-domain rotation coefficients associated with a set of TRPs through which a UE communicates with the network node. The set of instructions, when executed by one or more processors of the network node, may cause the network node to transmit a set of RSs via the set of TRPs in overlapping time resources, the set of RSs having the set of time-domain rotation coefficients applied. The set of instructions, when executed by one or more processors of the network node, may cause the network node to receive an indication of TDCPs associated with TRPs of the set of TRPs.

Some aspects described herein relate to an apparatus for wireless communication. The apparatus may include means for receiving an indication of a set of time-domain rotation coefficients associated with a set of TRPs through which the UE communicates with a network node. The apparatus may include means for receiving a set of RSs from the set of TRPs in overlapping time resources, the set of RSs having the set of time-domain rotation coefficients applied. The apparatus may include means for transmitting an indication of TDCPs associated with TRPs of the set of TRPs.

Some aspects described herein relate to an apparatus for wireless communication. The apparatus may include means for transmitting an indication of a set of time-domain rotation coefficients associated with a set of TRPs through which a UE communicates with the network node. The apparatus may include means for transmitting a set of RSs via the set of TRPs in overlapping time resources, the set of RSs having the set of time-domain rotation coefficients applied. The apparatus may include means for receiving an indication of TDCPs associated with TRPs of the set of TRPs.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 illustrates an example logical architecture of a distributed radio access network (RAN), in accordance with the present disclosure.

FIG. 5 is a diagram illustrating an example of multi-transmission-reception-point (TRP) communication, in accordance with the present disclosure.

FIG. 6 is a diagram illustrating an example of Doppler spectrum measurement of multi-TRP configurations, in accordance with the present disclosure.

FIG. 7 is a diagram illustrating an example of Doppler spectrum measurement of multi-TRP configurations, in accordance with the present disclosure.

FIG. 8 is a diagram of an example associated with reference signals (RSs) in overlapping time resources, in accordance with the present disclosure.

FIG. 9 is a diagram illustrating an example of Doppler spectrum measurement of multi-TRP configurations, in accordance with the present disclosure.

FIG. 10 is a diagram illustrating an example process performed, for example, by a UE, in accordance with the present disclosure.

FIG. 11 is a diagram illustrating an example process performed, for example, by a network node, in accordance with the present disclosure.

FIG. 12 is a diagram of an example apparatus for wireless communication, in accordance with the present disclosure.

FIG. 13 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

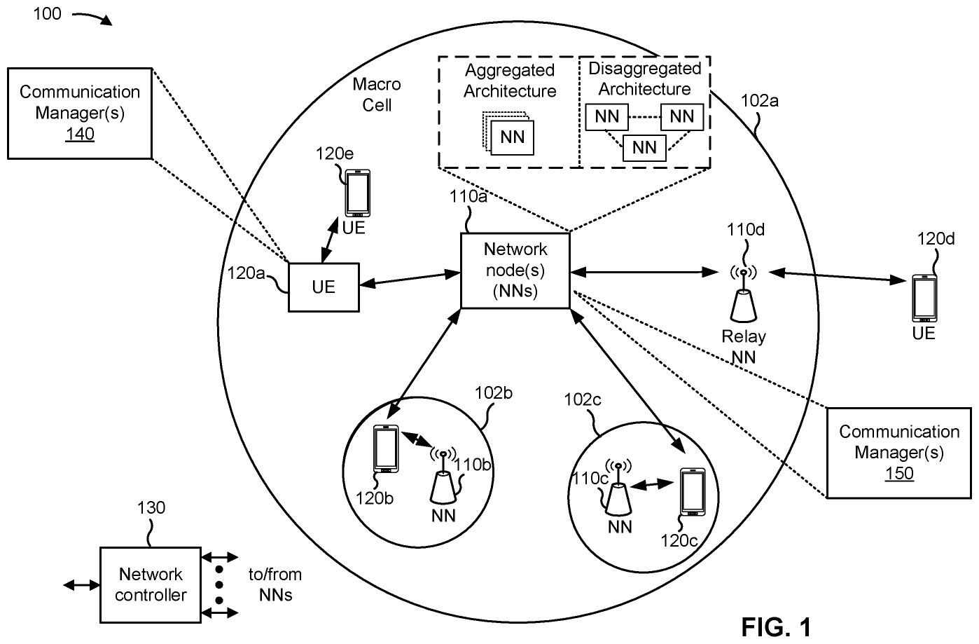

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive an indication of a set of time-domain rotation coefficients associated with a set of TRPs through which the UE communicates with a network node; receive a set of reference signals (RSs) from the set of TRPs in overlapping time resources, the set of RSs having the set of time-domain rotation coefficients applied; and transmit an indication of TDCPs associated with TRPs of the set of TRPs. Additionally, or alternatively, the communication manager 140 may perform one or more other operations described herein.

In some aspects, the network node 110 may include a communication manager 150. As described in more detail elsewhere herein, the communication manager 150 may transmit an indication of a set of time-domain rotation coefficients associated with a set of TRPs through which a UE communicates with the network node; transmit a set of RSs via the set of TRPs in overlapping time resources, the set of RSs having the set of time-domain rotation coefficients applied; and receive an indication of TDCPs associated with TRPs of the set of TRPs. Additionally, or alternatively, the communication manager 150 may perform one or more other operations described herein.

As indicated above, FIG. 1 is provided as an example. Other examples may differ from what is described with regard to FIG. 1.

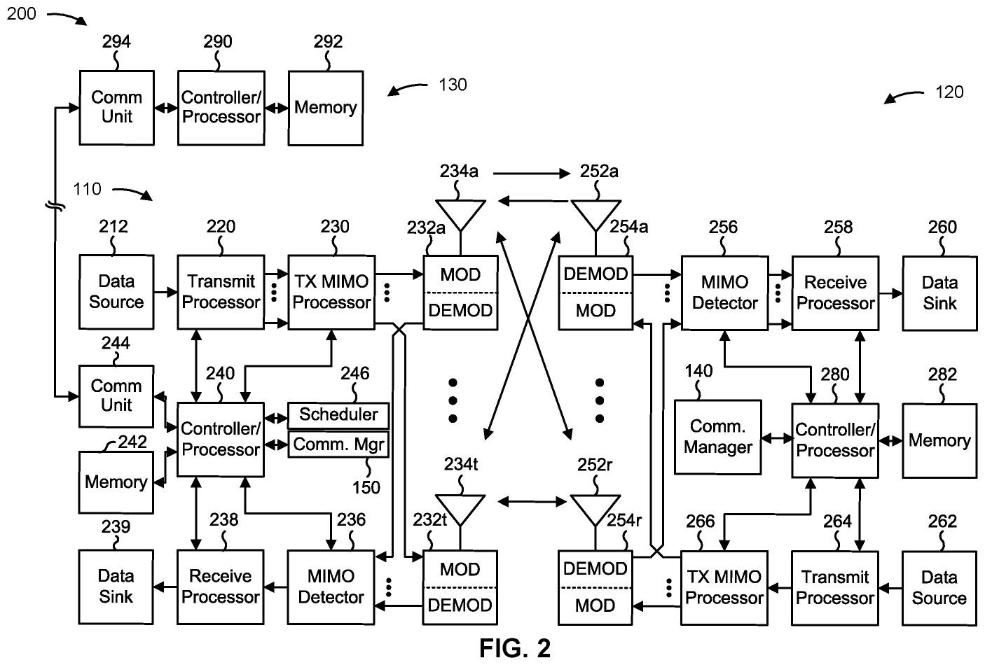

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

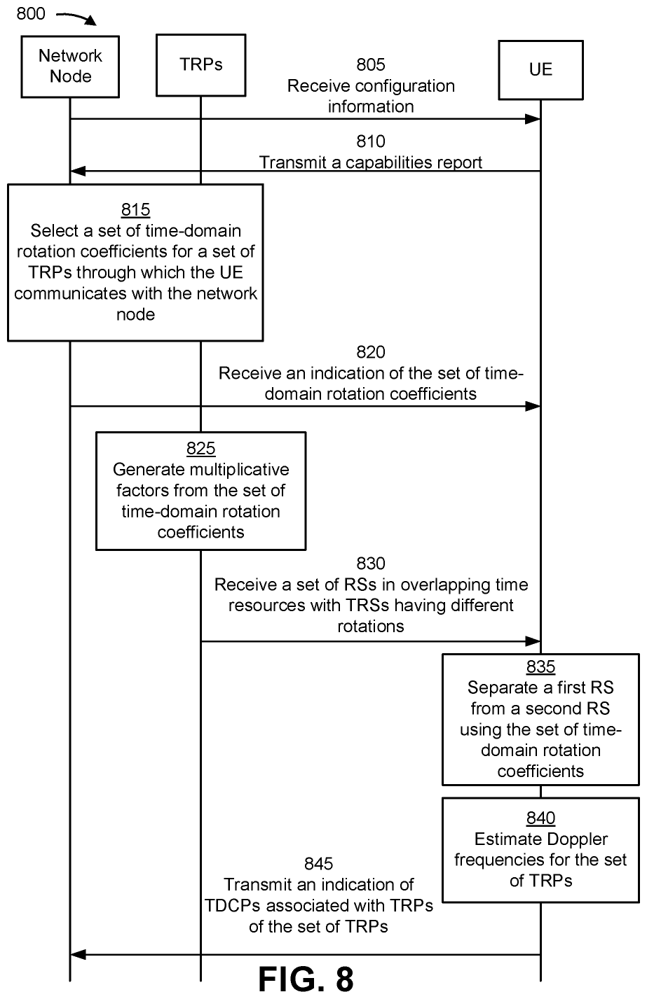

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 8-13).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 8-13).

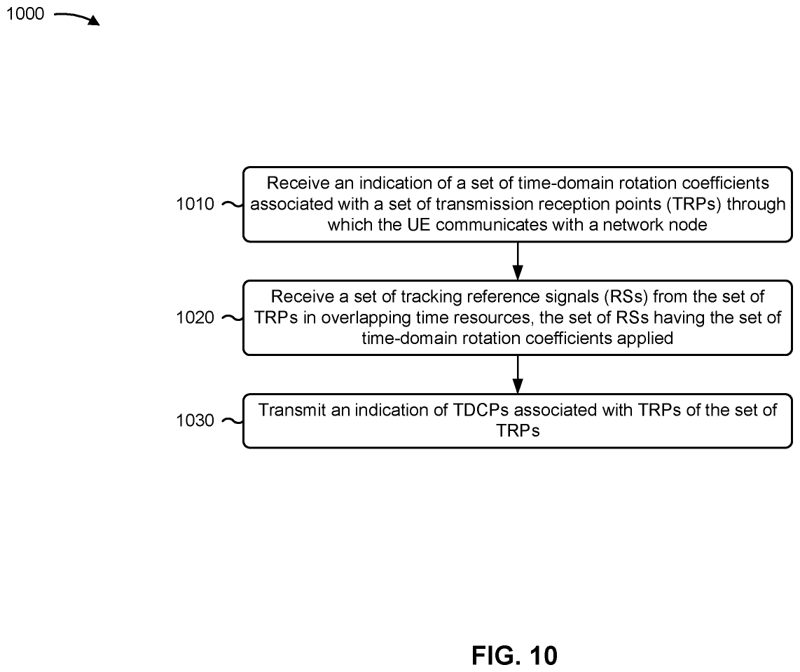

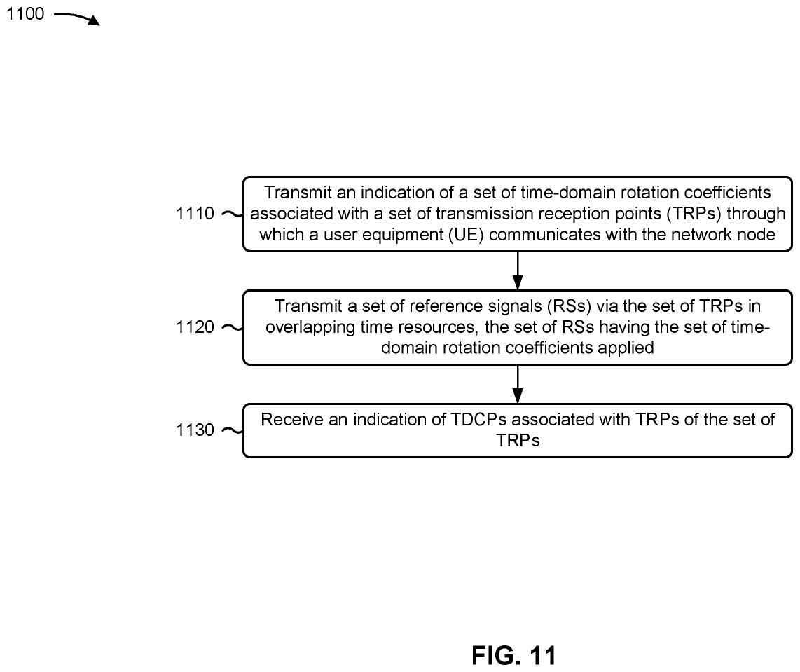

The controller/processor 240 of the network node 110, the controller/processor 280 of the UE 120, and/or any other component(s) of FIG. 2 may perform one or more techniques associated with RSs in overlapping time resources, as described in more detail elsewhere herein. For example, the controller/processor 240 of the network node 110, the controller/processor 280 of the UE 120, and/or any other component(s) of FIG. 2 may perform or direct operations of, for example, process 1000 of FIG. 10, process 1100 of FIG. 11, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, the UE includes means for receiving an indication of a set of time-domain rotation coefficients associated with a set of TRPs through which the UE communicates with a network node; means for receiving a set of RSs from the set of TRPs in overlapping time resources, the set of RSs having the set of time-domain rotation coefficients applied; and/or means for transmitting an indication of TDCPs associated with TRPs of the set of TRPs. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node includes means for transmitting an indication of a set of time-domain rotation coefficients associated with a set of TRPs through which a UE communicates with the network node; means for transmitting a set of RSs via the set of TRPs in overlapping time resources, the set of RSs having the set of time-domain rotation coefficients applied; and/or means for receiving an indication of TDCPs associated with TRPs of the set of TRPs. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

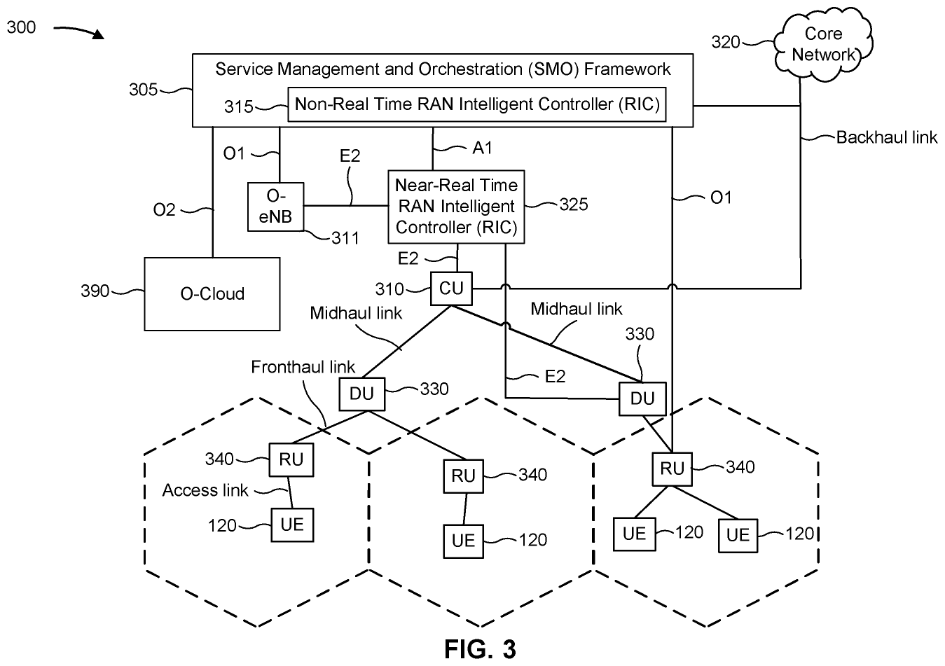

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

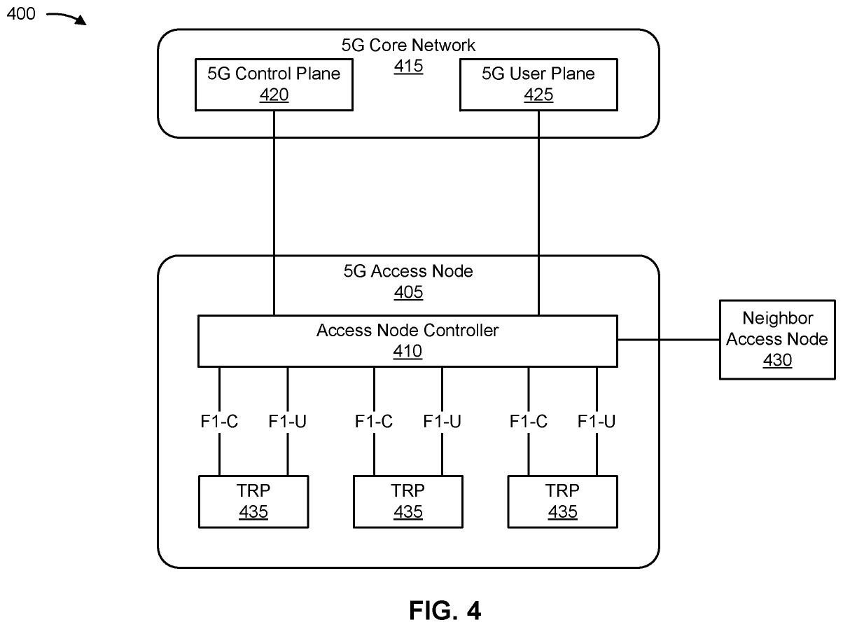

FIG. 4 illustrates an example logical architecture of a distributed RAN 400, in accordance with the present disclosure.

A 5G access node 405 may include an access node controller 410. The access node controller 410 may be a central unit (CU) of the distributed RAN 400. In some aspects, a backhaul interface to a 5G core network 415 may terminate at the access node controller 410. The 5G core network 415 may include a 5G control plane component 420 and a 5G user plane component 425 (e.g., a 5G gateway), and the backhaul interface for one or both of the 5G control plane and the 5G user plane may terminate at the access node controller 410. Additionally, or alternatively, a backhaul interface to one or more neighbor access nodes 430 (e.g., another 5G access node 405 and/or an LTE access node) may terminate at the access node controller 410.

The access node controller 410 may include and/or may communicate with one or more TRPs 435 (e.g., via an F1 Control (F1-C) interface and/or an F1 User (F1-U) interface). A TRP 435 may include a distributed unit (DU) and/or a radio unit (RU) of the distributed RAN 400. In some aspects, a TRP 435 may correspond to a network node 110 described above in connection with FIG. 1. For example, different TRPs 435 may be included in different network nodes 110. Additionally, or alternatively, multiple TRPs 435 may be included in a single network node 110. In some aspects, a network node 110 may include a CU (e.g., access node controller 410) and/or one or more DUs (e.g., one or more TRPs 435). In some cases, a TRP 435 may be referred to as a cell, a panel, an antenna array, or an array.

A TRP 435 may be connected to a single access node controller 410 or to multiple access node controllers 410. In some aspects, a dynamic configuration of split logical functions may be present within the architecture of distributed RAN 400, referred to elsewhere herein as a functional split. For example, a packet data convergence protocol (PDCP) layer, a radio link control (RLC) layer, and/or a medium access control (MAC) layer may be configured to terminate at the access node controller 410 or at a TRP 435.

In some aspects, multiple TRPs 435 may transmit communications (e.g., the same communication or different communications) in the same transmission time interval (TTI) (e.g., a slot, a mini-slot, a subframe, or a symbol) or different TTIs using different quasi co-location (QCL) relationships (e.g., different spatial parameters, different transmission configuration indicator (TCI) states, different precoding parameters, and/or different beamforming parameters). In some aspects, a TCI state may be used to indicate one or more QCL relationships. A TRP 435 may be configured to individually (e.g., using dynamic selection) or jointly (e.g., using joint transmission with one or more other TRPs 435) serve traffic to a UE 120.

As indicated above, FIG. 4 is provided as an example. Other examples may differ from what was described with regard to FIG. 4.

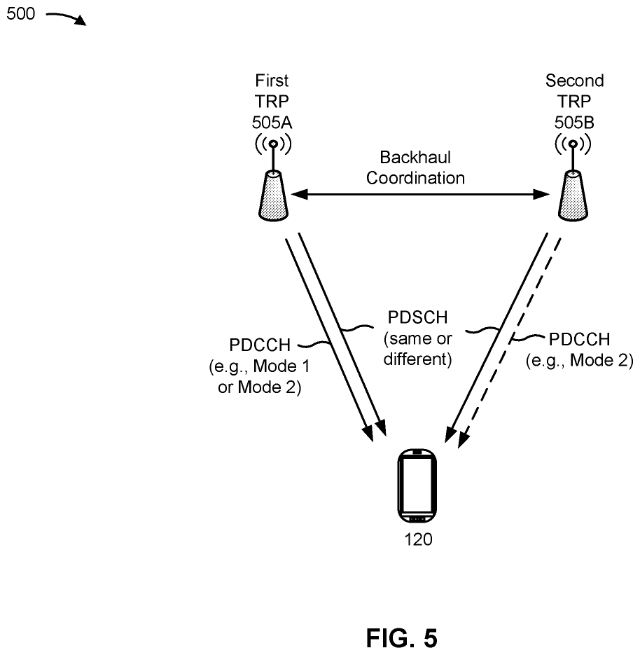

FIG. 5 is a diagram illustrating an example 500 of multi-TRP communication (sometimes referred to as multi-panel communication), in accordance with the present disclosure. As shown in FIG. 5, multiple TRPs 505 may communicate with the same UE 120. A TRP 505 may correspond to a TRP 435 described above in connection with FIG. 4.

The multiple TRPs 505 (shown as first TRP 505A and second TRP 505B) may communicate with the same UE 120 in a coordinated manner (e.g., using coordinated multipoint transmissions) to improve reliability and/or increase throughput. The TRPs 505 may coordinate such communications via an interface between the TRPs 505 (e.g., a backhaul interface and/or an access node controller 410). The interface may have a smaller delay and/or higher capacity when the TRPs 505 are co-located at the same network node 110 (e.g., when the TRPs 505 are different antenna arrays or panels of the same network node 110), and may have a larger delay and/or lower capacity (as compared to co-location) when the TRPs 505 are located at different network nodes 110. The different TRPs 505 may communicate with the UE 120 using different QCL relationships (e.g., different TCI states), different demodulation reference signal (DMRS) ports, and/or different layers (e.g., of a multi-layer communication).

In a first multi-TRP transmission mode (e.g., Mode 1), a single physical downlink control channel (PDCCH) may be used to schedule downlink data communications for a single physical downlink shared channel (PDSCH). In this case, multiple TRPs 505 (e.g., TRP A and TRP B) may transmit communications to the UE 120 on the same PDSCH. For example, a communication may be transmitted using a single codeword with different spatial layers for different TRPs 505 (e.g., where one codeword maps to a first set of layers transmitted by a first TRP 505 and maps to a second set of layers transmitted by a second TRP 505). As another example, a communication may be transmitted using multiple codewords, where different codewords are transmitted by different TRPs 505 (e.g., using different sets of layers). In either case, different TRPs 505 may use different QCL relationships (e.g., different TCI states) for different DMRS ports corresponding to different layers. For example, a first TRP 505 may use a first QCL relationship or a first TCI state for a first set of DMRS ports corresponding to a first set of layers, and a second TRP 505 may use a second (different) QCL relationship or a second (different) TCI state for a second (different) set of DMRS ports corresponding to a second (different) set of layers. In some aspects, a TCI state in downlink control information (DCI) (e.g., transmitted on the PDCCH, such as DCI format 1_0 or DCI format 1_1) may indicate the first QCL relationship (e.g., by indicating a first TCI state) and the second QCL relationship (e.g., by indicating a second TCI state). The first and the second TCI states may be indicated using a TCI field in the DCI. In general, the TCI field can indicate a single TCI state (for single-TRP transmission) or multiple TCI states (for multi-TRP transmission as discussed here) in this multi-TRP transmission mode (e.g., Mode 1).

In a second multi-TRP transmission mode (e.g., Mode 2 and/or a multi-DCI multi-TRP mode), multiple PDCCHs may be used to schedule downlink data communications for multiple corresponding PDSCHs (e.g., one PDCCH for each PDSCH). In this case, a first PDCCH may schedule a first codeword to be transmitted by a first TRP 505, and a second PDCCH may schedule a second codeword to be transmitted by a second TRP 505. Furthermore, first DCI (e.g., transmitted by the first TRP 505) may schedule a first PDSCH communication associated with a first set of DMRS ports with a first QCL relationship (e.g., indicated by a first TCI state) for the first TRP 505, and second DCI (e.g., transmitted by the second TRP 505) may schedule a second PDSCH communication associated with a second set of DMRS ports with a second QCL relationship (e.g., indicated by a second TCI state) for the second TRP 505. In this case, DCI (e.g., having DCI format 1_0 or DCI format 1_1) may indicate a corresponding TCI state for a TRP 505 corresponding to the DCI. The TCI field of a DCI indicates the corresponding TCI state (e.g., the TCI field of the first DCI indicates the first TCI state and the TCI field of the second DCI indicates the second TCI state).

As indicated above, FIG. 5 is provided as an example. Other examples may differ from what is described with respect to FIG. 5.

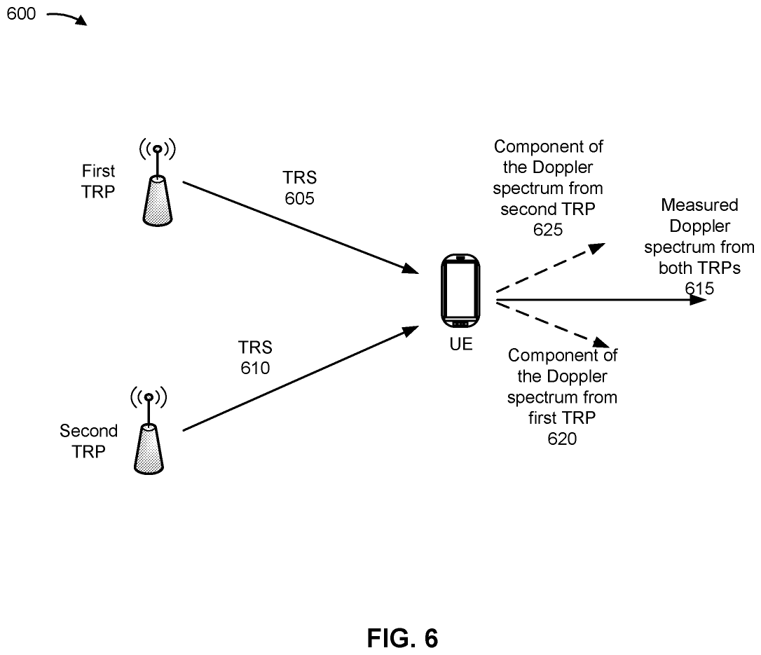

FIG. 6 is a diagram illustrating an example 600 of Doppler spectrum measurement of multi-TRP configurations, in accordance with the present disclosure. As shown in FIG. 6, a UE may communicate with a first TRP and a second TRP. For example, the UE may communicate with a network node via the first TRP and the second TRP. The first TRP and the second TRP may be part of a same cell (e.g., a serving cell and/or a special cell (SpCell)).

In some scenarios, such as high-speed movement scenarios, a network node may request that the UE measure a Doppler frequency and report the Doppler frequency to the network node. If a channel has Doppler frequency fa, channel responses with time interval T satisfy h₂=h₁·e^{j2πf}^{_{d}}^{T},

$${f}_{d} = \frac{v}{c} {f}_{c} .$$

The network node transmits RSs (e.g., tracking reference signals (TRSs)) periodically with time interval T. The UE may estimate channel responses [ĥ₀, ĥ₁, . . . , ĥ_{N-1}] at N time occasions. Then, the Doppler frequency estimation result can be

$${\hat{f}}_{d} = \frac{1}{2 π T} \cdot \frac{1}{N - 1} \cdot {\sum }_{n = 1}^{N - 1} phase ( \frac{{\hat{h}}_{n}}{{\overline{\hat{h}}}_{n - 1}} ) .$$

An accuracy of \hat{f}_{d} is related to a number of used time occasions N.

As shown by reference number 605, the UE may receive, and the first TRP may transmit, an RS 605. As shown by reference number 610, the UE may receive, and the second TRP may transmit, an RS 610. RSs may be used to measure one or more parameters associated with movement of the UE. For example, the RSs may be used to measure velocity of the UE and/or a Doppler effect on signals transmitted by the TRPs, as observed by the UE.

As shown by reference number 615, the UE may obtain a measured Doppler spectrum from both TRPs. For example, based at least in part on the first TRP transmitting the RS 605 and the second TRP transmitting the RS 610 in a same time resource, the measured Doppler spectrum may be a combination of a component of the Doppler spectrum from the first TRP 620 and a component of the Doppler spectrum from the second TRP 625. The measured Doppler spectrum may be associated with the component of the Doppler spectrum from the first TRP 620 and the component of the Doppler spectrum from the second TRP 625. The measured Doppler spectrum from both TRPs 615 may be an inaccurate representation of the Doppler spectrum of the component of the Doppler spectrum from the first TRP 620 and the component of the Doppler spectrum from the second TRP 625 based at least in part on being an aggregated measurement of the components.

In some networks, the UE may transmit an indication of the measured Doppler spectrum from both TRPs 615. The indication may be part of RS-based time domain channel property (TDCP) reporting. The TDCP reporting may include stand-alone auxiliary feedback information to enable refinement of channel state information (CSI) reporting configuration, codebook configuration parameters, network-node-side CSI prediction, and/or aiding network node implementation in CSI prediction for time-division duplexing (TDD).

In some networks, the TDCP may be based at least in part on a Doppler profile. For example, the TDCP may be based at least in part on a Doppler spread derived from a second moment of Doppler power spectrum, an average Doppler shifts, a Doppler shift per resource, a maximum Doppler shift, and/or a relative Doppler shift.

In some networks, the TDCP may be based at least in part on a time-domain correlation profile. For example, the TDCP may be based at least in part on a correlation within one RS resource and/or a correlation across multiple RS resources, among other examples. The correlation over one or more lags of RS resource may be considered. The lags may be within one RS burst or different RS bursts

In some networks, the TDCP may be based at least in part on a CSI reference signal (CSI-RS) resource and/or one or more CSI reporting setting configuration parameters to assist a network. For example, the network node may configure the UE with multiple options for what to assist, such as two or more CSI-RS or report periodicities or precoding schemes depending on a UE velocity. The UE may then report according to the configuration. In some networks, the network node may configure the UE with parameters correspond to CSI reporting periodicity or codebook type, among other examples.

As indicated above, FIG. 6 is provided as an example. Other examples may differ from what is described with respect to FIG. 6.

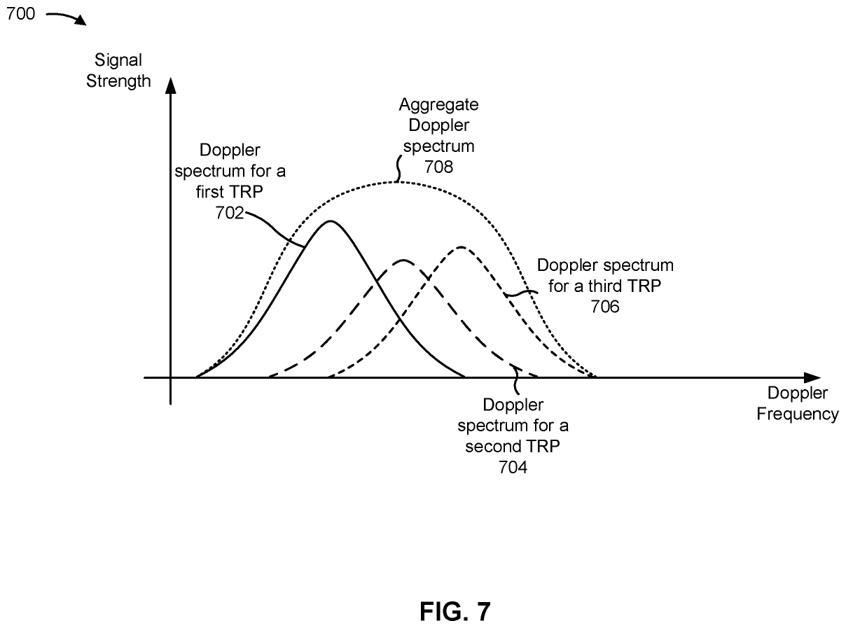

FIG. 7 is a diagram illustrating an example 700 of Doppler spectrum measurement of multi-TRP configurations, in accordance with the present disclosure. As shown in FIG. 7, a UE may receive a set of RSs from a first TRP, a second TRP, and a third TRP. For example, the UE may receive a first RS from the first TRP, a second RS from the second TRP, and a third RS from the third TRP. The UE may receive the set of RSs in overlapping time resources.

As shown in FIG. 7, the UE may receive, and the first TRP may transmit, a first RS that may be measured at the UE with a Doppler spectrum for the first TRP 702. Additionally, the UE may receive, and the second TRP may transmit, a second RS that may be measured at the UE with a Doppler spectrum for the second TRP 704. Further, the UE may receive, and the third TRP may transmit, a third RS that may be measured at the UE with a Doppler spectrum for the third TRP 706.

However, based at least in part on the first TRP, the second TRP, and the third TRP using overlapping time resources to transmit the first RS, the second RS, and the third RS, the UE may measure an aggregate Doppler spectrum 708. The UE may report the aggregate Doppler spectrum 708, which may be an inaccurate representation of one or more of the Doppler spectrum for the first TRP 702, the Doppler spectrum for the second TRP 704, or the Doppler spectrum for the third TRP 706. The network node may use the information associated with the Doppler spectrum 708 to configure communications between the UE and the TRPs. However, based at least in part on the information being inaccurate representations of the one or more Doppler spectra, configurations of the communications between the UE and the TRP may be mis-calibrated, which may result in communication errors and/or reduced spectral efficiency.

In some networks, the first TRP, the second TRP, and the third TRP may transmit the set of RSs using different time resources to improve accuracy of the information. However, the RSs may consume additional network resources, which may increase overhead and reduce spectral efficient, or the information may be less accurate based at least in part on the UE receiving RSs with reduced frequency (e.g. with an increased amount of time between RSs of a same TRP).

In some aspects described herein, a network may enable simultaneous RS (e.g., TRS and/or CSI-RS) transmissions by multiple TRPs at a shared time-resource, based at least in part on the TRPs using different time-domain rotation coefficients. In this way, the UE may separate and/or decompose a received signal into RSs associated with different TRPs. Additionally, in networks where transmission power restrictions are per TRP, simultaneous transmission may not impact a maximum transmission power of each TRP.

In some aspects, a network node may determine and indicate different time-domain rotation coefficients to the UE. Each TRP may transmit reference signals at the same time occasions with different time-domain rotation coefficients so that the UE may receive the TRPs with Doppler spectrums that are non-overlapping. For example, the UE may separate the reference signals of multiple TRPs based at least in part on the indicated time-domain rotation coefficients.

Based at least in part on using overlapping time-resources for multiple RSs from multiple TRPs, networks with a given number of time occasions used by each TRP, the network may reduce a total number of consumed time occasions to transmit a same number of RSs. In some networks with a given number of time occasions for RS-based Doppler measurement (e.g., multi-TRP-based Doppler measurement), the network may improve signal-to-noise ratio (SNR) and Doppler estimation accuracy.

To separate the Doppler frequencies of multiple paths from different TRPs, a network node determines different rotation coefficients

$${\{ {Δ}_{m} \}}_{m = 1}^{M}$$

for different TRPs. The network node configures these rotation coefficients

$${\{ {Δ}_{m} \}}_{m = 1}^{M}$$

to the UE. One rotation coefficient value (e.g., a respective rotation coefficient value) is associated with the RS resource of a respective TRP. For example, each TRP maps to different rotation coefficient values.

In some aspects, each TRP (m=1˜M) transmits an RS based at least in part on multiplicative factors e^{j2πΔ}^{ₘ}^{lT} at multiple periodical time occasions l=0˜L−1 (with interval T).

The UE may separate the Doppler spectra of the received signals from different TRPs based on

$${\{ {Δ}_{m} \}}_{m = 1}^{M} .$$

Then, the UE may estimate a Doppler frequency for each separated Doppler spectrum (e.g., for each TRP). The UE may report the measured Doppler frequency to the network node. For TRP m, the reported Doppler frequency value may be equal to the measured value minus Δₘ.

In some aspects, a network node may determine

$${\{ {Δ}_{m} \}}_{m = 1}^{M}$$

### for M TRPs.

$${f}_{d , max} = \frac{{v}_{max}}{c} \cdot {f}_{c}$$

is a maximum value of Doppler frequencies of all TRP-to-UE paths, which may be determined based at least in part on a protocol-regulated maximum moving velocity vₘₐₓ of the UE. Additionally, or alternatively, the UE may report a maximum moving speed of the UE.

To make the Doppler spectrum of all RSs of the TRPs non-overlapping, a maximum measurable Doppler frequency should satisfy

$${f}_{d , max , measure} = \frac{1}{T} \geq M . {f}_{d , max} ,$$

where T is the RS time interval and M is a number of TPRs. To make the Doppler spectrum of each TRP have equal space size,

$${Δ}_{0} = \frac{{f}_{d , max , measure}}{M} = \frac{1}{M T} \geq {f}_{d , max} .$$

The network node may configure a TRP m with

$${Δ}_{m} = ( m - 1 ) {Δ}_{0} = \frac{m - 1}{M T}$$

In some aspects,

$${L}_{0} = \frac{L}{M}$$

is a positive integer, where L is a number of RS time occasions. At time occasion l, TRP m transmits an RS at a plurality of REs based on multiplicative factor e^{j2πΔ}^{ₘ}^{lT}. Specifically, the multiplicative factor e^{j2πΔ}^{ₘ}^{lT} may be multiplied to an original RS symbol p_{k,l} at subcarrier k and time occasion l, resulting in the actual transmitted RS symbol

$${\tilde{p}}_{k , l} = {p}_{k , l} {e}^{j 2 π {Δ}_{m} l T} .$$

At reception, the UE may calculate a Doppler frequency of each TRP at respective equivalent Doppler spectra based at least in part on Δₘ, in which TRP interference may be avoided or reduced. The UE may estimate a channel response based on the original RS symbol p_{k,l}, resulting in an overall equivalent channel response

$${\overline{h}}_{k , l} = {\sum }_{m = 1}^{M} {\tilde{h}}_{k , l}^{( m )} = {\sum }_{m = 1}^{M} {h}_{k , l}^{( m )} {e}^{j 2 π {Δ}_{m} l T} ,$$

where

$${h}_{k , l}^{( m )} and {\tilde{h}}_{k , l}^{( m )}$$

are the original or equivalent channel responses at subcarrier k and time occasion l, respectively.

The UE may sum up estimated channel responses at all subcarriers and time occasion l as

$${\overline{\overline{h}}}_{l} = {\sum }_{k = 0}^{K - 1} {\overline{h}}_{k , l} .$$

The UE may derive Doppler spectra of the estimated channel responses at multiple (L) time occasions by performing a discrete Fourier transform (DFT) to the overall equivalent channel response [h̅_{k,0}, h̅_{k,1}, . . . , h̅_{k,L-1}] or [h̅₀, h̅₁, . . . , h̅_{L-1}].

Original or equivalent channel response vectors at one or all the subcarriers and at multiple (L) occasions may be represented as

$${h}_{k}^{( m )} = [ {h}_{k , 0}^{( m )} , {h}_{k , 1}^{( m )} , … , {h}_{k , L - 1}^{( m )} ] ,$$

$${h}^{( m )} = [ {\sum }_{k = 0}^{K - 1} {h}_{k , 0} , {\sum }_{k = 0}^{K - 1} {h}_{k , 1} , … , {\sum }_{k = 0}^{K - 1} {h}_{k , L - 1} ] ,$$

$${\tilde{h}}_{k}^{( m )} = [ {\tilde{h}}_{k , 0}^{( m )} , {\tilde{h}}_{k , 1}^{( m )} , … , {\tilde{h}}_{k , L - 1}^{( m )} ] or$$

$${\tilde{h}}^{( m )} = [ {\sum }_{k = 0}^{K - 1} {\tilde{h}}_{k , 0} , {\sum }_{k = 0}^{K - 1} {\tilde{h}}_{k , 1} , … , {\sum }_{k = 0}^{K - 1} {\tilde{h}}_{k , L - 1} ] ,$$

respectively.

$${\overline{\overline{h}}}_{l} = {\sum }_{k = 0}^{K - 1} {\sum }_{m = 1}^{M} {\tilde{h}}_{k , l}^{( m )} = {\sum }_{m = 1}^{M} {\sum }_{k = 0}^{K - 1} {\tilde{h}}_{k , l}^{( m )} = {\sum }_{m = 1}^{M} {\sum }_{k = 0}^{K - 1} {\tilde{h}}_{k , l}^{( m )} .$$

The Doppler spectrum of

$${\tilde{h}}_{k}^{( m )} or {\tilde{h}}^{( m )}$$

for an equivalent channel responses is a shifted version of the Doppler spectrum

$${h}_{k}^{( m )}$$

or h^{(m)} for the original channel response. For example, if the Doppler spectra are represented as

$${H}_{k}^{( m )} = DFT ( {h}_{k}^{( m )} ) , {H}^{( m )} = DFT ( {h}^{( m )} ) ,$$

$${\tilde{H}}_{k}^{( m )} = DFT ( {\tilde{h}}_{k}^{( m )} ) , {\tilde{H}}^{( m )} = DFT ( {\tilde{h}}^{( m )} ) ,$$

then

$${\tilde{H}}_{k}^{( m )} ( l ) = {H}_{k}^{( m )} ( mod ( l - ( m - 1 ) {L}_{0} , L ) ) ,$$

$${\tilde{H}}^{( m )} ( l ) = {H}^{( m )} ( mod ( l - ( m - 1 ) {L}_{0} , L ) ) .$$

This means the equivalent Doppler spectrum of TRP m is shifted right-ward with the length of (m−1)L₀.

Based at least in part on

$${f}_{d , max} \leq \frac{{f}_{d , max , measure}}{M}$$

and different TRPs have different shifting lengths, equivalent Doppler spectra are non-overlapping (e.g., at least in a range of a majority of associated signal strength in the spectra), and thus when the TRPs simultaneously transmit RS with different rotation coefficients

$${\{ {Δ}_{m} \}}_{m = 1}^{M} ,$$

the mutual interference in Doppler spectra at the UE is avoided or reduced.

Based at least in part on

$$DFT ( [ {\overline{h}}_{k , 0} , {\overline{h}}_{k , 1} , … , {\overline{h}}_{k , L - 1} ] ) = {\sum }_{m = 1}^{M} DFT ( {\tilde{h}}_{k}^{( m )} ) ,$$

$$DFT ( [ {\overline{\overline{h}}}_{0} , {\overline{\overline{h}}}_{1} , … , {\overline{\overline{h}}}_{L - 1} ] ) = {\sum }_{m = 1}^{M} DFT ( {\tilde{h}}^{( m )} ) ,$$

the derived Doppler spectrum is the concatenation of length-L₀ Doppler spectrums of received signal from each TRP. The Doppler frequency of each TRP can be derived at the Doppler spectrum of such TRP. For example, the UE may use a frequency value with the highest power in Doppler spectrum. This example has lower complexity and may be used with a high number of RS time occasions.

In another example, the UE may shift a TRP-specific Doppler spectrum

$$( {f}_{d} ∈ [ - \frac{{L}_{0}}{2} + ( m - 1 ) {L}_{0} , \frac{{L}_{0}}{2} + ( m - 1 ) {L}_{0} ] )$$

back with −(m−1)L₀, perform IDFT to obtain interference-free time-domain signals, then use a slope value of signal phases to estimate Doppler frequency. When L₀ is small, e.g., ≤4, there may be residual mutual-TRP interference if the Doppler frequency is not an integer times of

$$\frac{1}{LT} .$$

In this case, an iterative soft interference cancellation (SIC) approach may be used to remove the residual interference. This example has higher complexity and may be used with a small number of RS time occasions.

In some aspects, a number of periodic non-zero power (NZP) CSI-RS resources configured by a TRS-ResourceSet or RS-ResourceSet may be indicated by numberOfresources. Time-domain locations of two CSI-RS resources in a slot, or of four CSI-RS resources in two consecutive slots (which may be the same across two consecutive slots), is one of allow lϵ{4, 8}, lϵ{5, 9} or lϵ{6, 10} for FR1 and FR2. Or lϵ{0, 4}, lϵ{1, 5}, lϵ{2, 6}, lϵ{3, 7}, lϵ{7, 11}, lϵ{8, 12} or lϵ{9, 13} for FR2.

In some aspects in which RSs may use overlapping time resources, two TRPs may share OFDM symbols lϵ{4,6,8,10}. In this way, each TRP may use 4 OFDM symbols in one slot. This may increase SNR in Doppler frequency estimation. In some aspects, two TRPs may simultaneously transmit RSs with

$${Δ}_{1} = 0 , {Δ}_{2} = \frac{1}{2 T} ,$$

respectively. In this way, the network may allow lϵ{0, 1, 2, 3} or lϵ{4,6,8,10} for an RS-ResourceSet (e.g., an RS resource set corresponding to a single TRP). Additionally, or alternatively, a network node may configure a parameter of a “rotation coefficient” for an RS-ResourceSet.

FIG. 8 is a diagram of an example 800 associated with RSs in overlapping time resources, in accordance with the present disclosure. As shown in FIG. 8, a network node (e.g., network node 110, a CU, a DU, and/or an RU) may communicate with a UE (e.g., UE 120) via TRPs. In some aspects, the network node, the TRPs, and the UE may be part of a wireless network (e.g., wireless network 100). The UE and the network node may have established a wireless connection prior to operations shown in FIG. 8. The network node and the TRPs may be associated with a serving cell of the UE. In some aspects, the network node may be described as communicating with (e.g., transmitting to or receiving from) the UE, where communicating with the UE includes communicating with the UE via the TRPs. For example, a description of the network node transmitting a reference signal to the UE includes the network node providing the RS to a TRP for transmission to the UE or transmitting a command or configuration for the TRP to transmit the RS to the UE.

As shown by reference number 805, the network node may transmit, and the UE may receive, configuration information. In some aspects, the UE may receive the configuration information via one or more of RRC signaling, one or more MAC control elements (CEs), and/or DCI, among other examples. In some aspects, the configuration information may include an indication of one or more configuration parameters (e.g., already known to the UE and/or previously indicated by the network node or other network device) for selection by the UE, and/or explicit configuration information for the UE to use to configure the UE, among other examples.

In some aspects, the configuration information may indicate that the UE is to transmit a capabilities report to indicate whether the UE supports reception of multiple RSs in overlapping time resources. In some aspects, the configuration information may indicate one or more parameters for applying a set of time-domain rotation coefficients to separate RSs from different TRPs. In some aspects, the configuration information may indicate a number of TRPs through which the UE communications with the network node.

The UE may configure itself based at least in part on the configuration information. In some aspects, the UE may be configured to perform one or more operations described herein based at least in part on the configuration information.

As shown by reference number 810, the UE may transmit, and the network node may receive, a capabilities report. In some aspects, the capabilities report may indicate UE support for reception of multiple RSs in overlapping time resources based at least in part on application of different time-domain rotation coefficients associated with different TRPs (e.g., associated via control resource set (CORESET) pool identifiers).

As shown by reference number 815, the network node and the TRPs may select a set of time-domain rotation coefficients for a set of the TRPs through which the UE communications with the network node. In some aspects, the time-domain rotation coefficients may be based at least in part on a number of TRPs used for communications with the UE. For example, values of the time-domain rotation coefficients may be set such that Doppler spectra associated with the TRPs are spaced (e.g., evenly spaced) within a Doppler frequency domain.

In some aspects, the time-domain rotation coefficients may include a set of time-domain multiplicative factors or a set of time-domain phase shift additive factors. In some aspects, the time-domain rotation coefficients may shift signals of the RS in a complex domain.

As shown by reference number 820, the UE may receive, and the network node may transmit (e.g., via the set of TRPs), an indication of the set of time-domain rotation coefficients. For example, the UE may receive an indication of a set of time-domain rotation coefficients associated with the set of TRPs through which the UE communicates with the network node. In some aspects, one value of the time-domain rotation coefficients has a value of one (e.g., no shift applied). In some aspects, the other rotation coefficients may be rotations relative to the one value.

In some aspects, time-domain rotation coefficients are associated with different TRPs via associations with CORESET pool indices. For example a first time-domain rotation coefficient may be associated with a first TRP based at least in part on the first time-domain rotation coefficient and the first TRP being associated with a first CORESET pool index, and a second time-domain rotation coefficient may be associated with a second TRP based at least in part on the second time-domain rotation coefficient and the second TRP being associated with a second CORESET pool index.

As shown by reference number 825, the set of TRPs may generate multiplicative factors from the set of time-domain rotation coefficients. For example, a TRP may derive a multiplier, to apply to a signal of an RS, that is based at least in part on an assigned time-domain rotation coefficient.

As shown by reference number 830, the UE may receive, and the set of TRPs may transmit, a set of RSs (e.g., TRSs or CSI-RSs) in overlapping time resources with RSs having different rotations. For example RSs from a first TRP may have a first rotation (e.g., time-domain rotation), RSs from a second TRP may have a second rotation, etc. based at least in part on the set of RSs having the set of time-domain rotation coefficients applied. The transmission of the set of RSs in overlapping time resource may include simultaneous transmission, where at least two RSs of the set of RSs are transmitted by different TRPs at the same time, or where the UE receives at least two of the RSs at the same time.

In some aspects, the overlapping time resources include one or more of an RS time occasion or a time-domain (e.g., OFDM) symbol. In some aspects, the overlapping time resources include multiple time-domain symbols, with each of the multiple time-domain symbols being used to transmit multiple RSs. The UE may then receive multiple RSs within a single RS time occasion or within a single time-domain symbol.

As shown by reference number 835, the UE may separate a first RS from a second RS using the set of time-domain rotation coefficients. For example, the UE may separate the first RS from the second RS based at least in part on the first RS being associated with a first time-domain rotation coefficient and the second RS being associated with a second time-domain rotation. The first RS may be associated with a first TRP and the second RS may be associated with a second TRP.

As shown by reference number 840, the UE may estimate Doppler frequencies for the set of TRPs. In some aspects, the estimation of the Doppler frequencies may include applying a first time-domain rotation coefficient to the set of RS, identifying a first Doppler spectrum associated with the first time-domain rotation coefficient, and identifying, based at least in part on application of the first time-domain rotation coefficient, a first frequency value with a highest received power in the first Doppler spectrum. The UE may also apply a second time-domain rotation coefficient to the set of RSs, identify a second Doppler spectrum associated with the second time-domain rotation coefficient, and identifying, based at least in part on application of the first time-domain rotation coefficient, a second frequency value with a highest received power in the second Doppler spectrum. The indication of the Doppler frequencies associated with the TRPs of the set of TRPs may include an indication of the first frequency value associated with the first time-domain rotation coefficient and an indication of the second frequency value associated with the second time-domain rotation coefficient.

In some aspects, the estimation of the Doppler frequencies may include applying a first time-domain rotation coefficient to the set of RSs, identifying a first Doppler spectrum associated with the first time-domain rotation coefficient, shifting the first Doppler spectrum by an amount associated with the first time-domain rotation coefficient, obtaining a first time-domain signal associated with the first Doppler spectrum, and identifying a first estimated Doppler frequency based at least in part on a slope of phases of the first time-domain signal. The UE may also apply a second time-domain rotation coefficient to the set of RSs, identify a second Doppler spectrum associated with the second time-domain rotation coefficient, shift the second Doppler spectrum by an amount associated with the second time-domain rotation coefficient, obtain a second time-domain signal associated with the second Doppler spectrum, and identify a second estimated Doppler frequency based at least in part on a slope of phases of the second time-domain signal. The indication of the Doppler frequencies associated with the TRPs of the set of TRPs may include an indication of the first estimated Doppler frequency associated with the first time-domain rotation coefficient and an indication of the second estimated Doppler frequency associated with the second time-domain rotation coefficient.

As shown by reference number 845, the UE may transmit, and the network node may receive, an indication of TDCPs associated with TRPs of the set of TRPs. For example, the UE may transmit an indication of a first TDCP associated with a first TRP, a first RS, and/or a first time-domain rotation coefficient, and the UE may transmit an indication of a second TDCP associated with a second TRP, a second RS, and/or a second time-domain rotation coefficient, etc. In some aspects, a TDCP may be associated with a Doppler frequency, a Doppler spectrum, a time domain correlation coefficient, or a set of time-domain correlation coefficients, among other examples.

Based at least in part on using overlapping time-resources for multiple RSs from multiple TRPs, networks with a given the number of time occasions used by each TRP, the network may reduce a total number of consumed time occasions to transmit a same number of RSs. In some networks with a given number of time occasions for RS-based Doppler measurement (e.g., multi-TRP-based Doppler measurement), the network may improve SNR and Doppler estimation accuracy.

As indicated above, FIG. 8 is provided as an example. Other examples may differ from what is described with respect to FIG. 8.

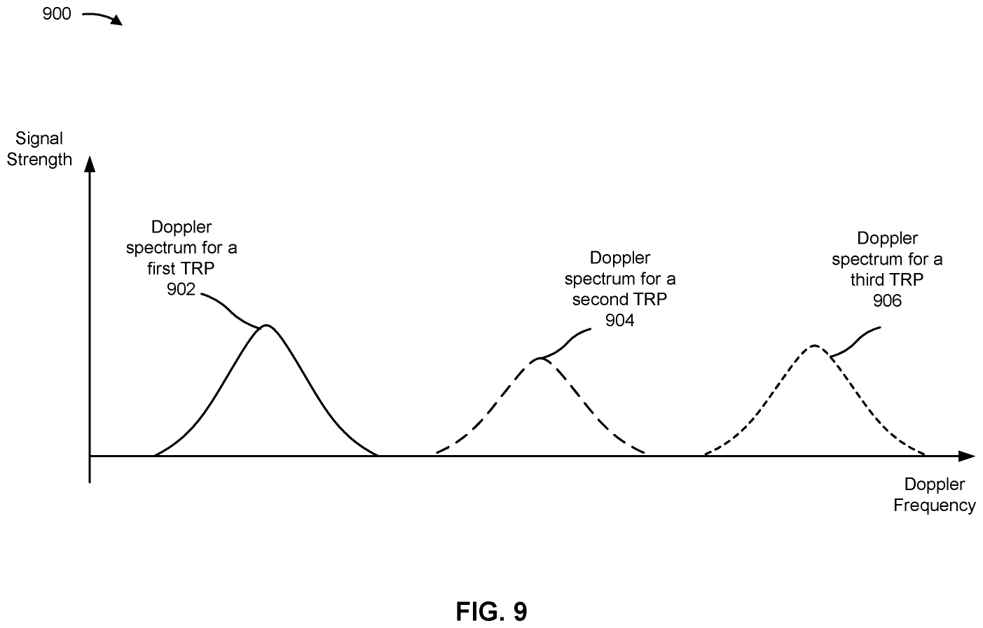

FIG. 9 is a diagram illustrating an example 900 of Doppler spectrum measurement of multi-TRP configurations, in accordance with the present disclosure. As shown in FIG. 9, a UE may receive a set of RSs from a first TRP, a second TRP, and a third TRP. For example, the UE may receive a first RS from the first TRP, a second RS from the second TRP, and a third RS from the third TRP. The UE may receive the set of RSs in overlapping time resources.

As shown in FIG. 9, the UE may receive, and the first TRP may transmit, a first RS that may be measured at the UE with a Doppler spectrum for the first TRP 902. Additionally, the UE may receive, and the second TRP may transmit, a second RS that may be measured at the UE with a Doppler spectrum for the second TRP 904. Further, the UE may receive, and the third TRP may transmit, a third RS that may be measured at the UE with a Doppler spectrum for the third TRP 906.

The UE may receive the first RS, the second RS, and the third RS in overlapping time resources. However, based at least in part on the first RS, the second RS, and the third RS having different multiplicative factors applied (e.g., based at least in part on the time-domain rotation coefficients) the UE may observe each of the first RS, the second RS, and the third RS with reduced mutual interference. For example, the Doppler spectrum for the second TRP 904 and the Doppler spectrum for the third TRP 906 may be shifted from the Doppler spectrum for the first TRP 902.

As indicated above, FIG. 9 is provided as an example. Other examples may differ from what is described with respect to FIG. 9.

FIG. 10 is a diagram illustrating an example process 1000 performed, for example, by a UE, in accordance with the present disclosure. Example process 1000 is an example where the UE (e.g., UE 120) performs operations associated with tracking reference signals in overlapping time resources.

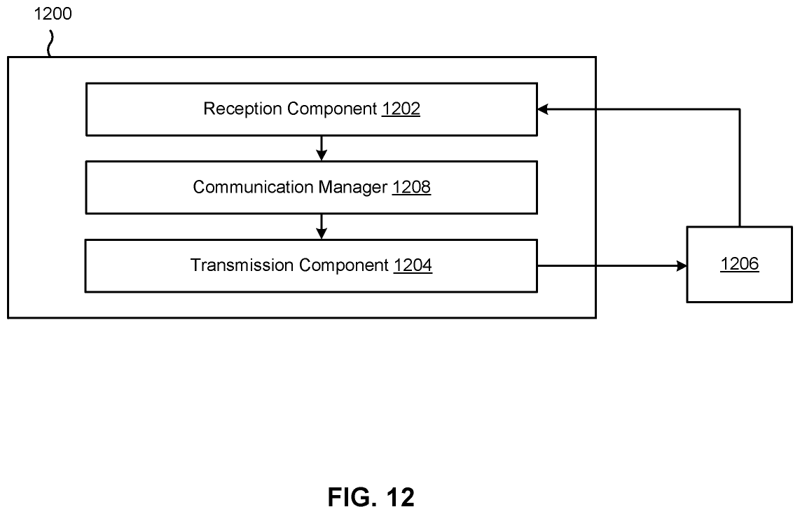

As shown in FIG. 10, in some aspects, process 1000 may include receiving an indication of a set of time-domain rotation coefficients associated with a set of TRPs through which the UE communicates with a network node (block 1010). For example, the UE (e.g., using communication manager 140 and/or reception component 1202, depicted in FIG. 12) may receive an indication of a set of time-domain rotation coefficients associated with a set of TRPs through which the UE communicates with a network node, as described above.

As further shown in FIG. 10, in some aspects, process 1000 may include receiving a set of RSs from the set of TRPs in overlapping time resources, the set of RSs having the set of time-domain rotation coefficients applied (block 1020). For example, the UE (e.g., using communication manager 140 and/or reception component 1202, depicted in FIG. 12) may receive a set of RSs from the set of TRPs in overlapping time resources, the set of RSs having the set of time-domain rotation coefficients applied, as described above.

As further shown in FIG. 10, in some aspects, process 1000 may include transmitting an indication of TDCPs associated with TRPs of the set of TRPs (block 1030). For example, the UE (e.g., using communication manager 140 and/or transmission component 1204, depicted in FIG. 12) may transmit an indication of TDCPs associated with TRPs of the set of TRPs, as described above.

Process 1000 may include additional aspects, such as any single aspect or any combination of aspects described below and/or in connection with one or more other processes described elsewhere herein.

In a first aspect, process 1000 includes separating a first RS from a second RS based at least in part on the first RS being associated with a first time-domain rotation coefficient and the second RS being associated with a second time-domain rotation, wherein the first RS is associated with a first TRP and the second RS is associated with a second TRP.

In a second aspect, alone or in combination with the first aspect, a first time-domain rotation coefficient, of the set of time-domain rotation coefficients, is associated with a first TRP, of the set of TRPs, based at least in part on the first time-domain rotation coefficient and the first TRP being associated with a first CORESET pool index, and wherein a second time-domain rotation coefficient, of the set of time-domain rotation coefficients, is associated with a second TRP, of the set of TRPs, based at least in part on the second time-domain rotation coefficient and the second TRP being associated with a second CORESET pool index.

In a third aspect, alone or in combination with one or more of the first and second aspects, transmitting the indication of TDCPs comprises transmitting a first indication of a first TDCP associated with a first rotation coefficient, and transmitting a second indication of a second TDCP associated with a second rotation coefficient.

In a fourth aspect, alone or in combination with one or more of the first through third aspects, process 1000 includes applying a first time-domain rotation coefficient to the set of RSs, identifying a first Doppler spectrum associated with the first time-domain rotation coefficient, identifying, based at least in part on application of the first time-domain rotation coefficient, a first frequency value with a highest received power in the first Doppler spectrum, applying a second time-domain rotation coefficient to the set of RSs, identifying a second Doppler spectrum associated with the second time-domain rotation coefficient, and identifying, based at least in part on application of the first time-domain rotation coefficient, a second frequency value with a highest received power in the second Doppler spectrum, wherein the indication of the Doppler frequencies associated with the TRPs of the set of TRPs includes an indication of the first frequency value associated with the first time-domain rotation coefficient and an indication of the second frequency value associated with the second time-domain rotation coefficient.

In a fifth aspect, alone or in combination with one or more of the first through fourth aspects, process 1000 includes applying a first time-domain rotation coefficient to the set of RSs, identifying a first Doppler spectrum associated with the first time-domain rotation coefficient, shifting the first Doppler spectrum by an amount associated with the first time-domain rotation coefficient, obtaining a first time-domain signal associated with the first Doppler spectrum, identifying a first estimated Doppler frequency based at least in part on a slope of phases of the first time-domain signal, applying a second time-domain rotation coefficient to the set of RSs, identifying a second Doppler spectrum associated with the second time-domain rotation coefficient, shifting the second Doppler spectrum by an amount associated with the second time-domain rotation coefficient, obtaining a second time-domain signal associated with the second Doppler spectrum, and identifying a second estimated Doppler frequency based at least in part on a slope of phases of the second time-domain signal, wherein the indication of the Doppler frequencies associated with the TRPs of the set of TRPs includes an indication of the first estimated Doppler frequency associated with the first time-domain rotation coefficient and an indication of the second estimated Doppler frequency associated with the second time-domain rotation coefficient.

In a sixth aspect, alone or in combination with one or more of the first through fifth aspects, the set of time-domain rotation coefficients comprise a set of time-domain multiplicative factors or a set of time-domain phase shift additive factors.

In a seventh aspect, alone or in combination with one or more of the first through sixth aspects, the overlapping time resources comprise one or more of an RS time occasion or a time-domain symbol, and wherein receiving the set of RSs comprises receiving multiple RSs within a single RS time occasion or within a single time-domain symbol.

In an eighth aspect, alone or in combination with one or more of the first through seventh aspects, a time-domain rotation coefficient of the set of time-domain rotation coefficients has a value of one.

In a ninth aspect, alone or in combination with one or more of the first through eighth aspects, process 1000 includes transmitting an indication of support for receiving the set of RSs in overlapping time resources with the set of RSs having the set of time-domain rotation coefficients applied.

In a tenth aspect, alone or in combination with one or more of the first through ninth aspects, the set of RSs comprises a set of TRSs or a set of CSI-RSs.

In an eleventh aspect, alone or in combination with one or more of the first through tenth aspects, the TDCPs are associated with one or more of: a Doppler frequency, a Doppler spectrum, a time domain correlation coefficient, or a set of time-domain correlation coefficients.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network node, in accordance with the present disclosure. Example process 1100 is an example where the network node (e.g., network node 110) performs operations associated with tracking reference signals in overlapping time resources.

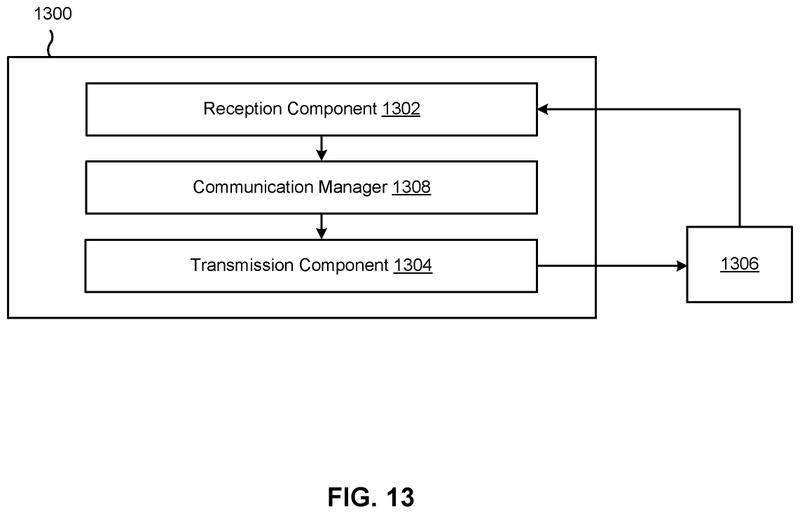

As shown in FIG. 11, in some aspects, process 1100 may include transmitting an indication of a set of time-domain rotation coefficients associated with a set of TRPs through which a UE communicates with the network node (block 1110). For example, the network node (e.g., using communication manager 150 and/or transmission component 1304, depicted in FIG. 13) may transmit an indication of a set of time-domain rotation coefficients associated with a set of TRPs through which a UE communicates with the network node, as described above.

As further shown in FIG. 11, in some aspects, process 1100 may include transmitting a set of RSs via the set of TRPs in overlapping time resources, the set of RSs having the set of time-domain rotation coefficients applied (block 1120). For example, the network node (e.g., using communication manager 150 and/or transmission component 1304, depicted in FIG. 13) may transmit a set of RSs via the set of TRPs in overlapping time resources, the set of RSs having the set of time-domain rotation coefficients applied, as described above.

As further shown in FIG. 11, in some aspects, process 1100 may include receiving an indication of TDCPs associated with TRPs of the set of TRPs (block 1130). For example, the network node (e.g., using communication manager 150 and/or reception component 1302, depicted in FIG. 13) may receive an indication of TDCPs associated with TRPs of the set of TRPs, as described above.

Process 1100 may include additional aspects, such as any single aspect or any combination of aspects described below and/or in connection with one or more other processes described elsewhere herein.

In a first aspect, process 1100 includes selecting the time-domain rotation coefficients based at least in part on a number of TRPs in the set of TRPs.

In a second aspect, alone or in combination with the first aspect, a first time-domain rotation coefficient, of the set of time-domain rotation coefficients, is associated with a first TRP, of the set of TRPs, based at least in part on the first time-domain rotation coefficient and the first TRP being associated with a first CORESET pool index, and wherein a second time-domain rotation coefficient, of the set of time-domain rotation coefficients, is associated with a second TRP, of the set of TRPs, based at least in part on the second time-domain rotation coefficient and the second TRP being associated with a second CORESET pool index.

In a third aspect, alone or in combination with one or more of the first and second aspects, receiving the indication of TDCPs comprises receiving a first indication of a first TDCP associated with a first rotation coefficient, and receiving a second indication of a second TDCP associated with a second rotation coefficient.

In a fourth aspect, alone or in combination with one or more of the first through third aspects, the set of time-domain rotation coefficients comprise a set of time-domain multiplicative factors or a set of time-domain phase shift additive factors.

In a fifth aspect, alone or in combination with one or more of the first through fourth aspects, the overlapping time resources comprise one or more of an RS time occasion or a time-domain symbol, and wherein transmitting the set of RSs comprises transmitting multiple RSs within a single RS time occasion or within a single time-domain symbol.

In a sixth aspect, alone or in combination with one or more of the first through fifth aspects, a time-domain rotation coefficient of the set of time-domain rotation coefficients has a value of one.

In a seventh aspect, alone or in combination with one or more of the first through sixth aspects, process 1100 includes receiving an indication of support for receiving the set of RSs in overlapping time resources with the set of RSs having the set of time-domain rotation coefficients applied.

In an eighth aspect, alone or in combination with one or more of the first through seventh aspects, the set of RSs comprises a set of TRSs or a set of CSI-RSs.

In a ninth aspect, alone or in combination with one or more of the first through eighth aspects, the TDCPs are associated with one or more of: a Doppler frequency, a Doppler spectrum, a time domain correlation coefficient, or a set of time-domain correlation coefficients.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a UE, or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include a communication manager 1208 (e.g., the communication manager 140).

In some aspects, the apparatus 1200 may be configured to perform one or more operations described herein in connection with FIGS. 8-9. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

The reception component 1202 may receive an indication of a set of time-domain rotation coefficients associated with a set of TRPs through which the UE communicates with a network node. The reception component 1202 may receive a set of RSs from the set of TRPs in overlapping time resources, the set of RSs having the set of time-domain rotation coefficients applied. The transmission component 1204 may transmit an indication of TDCPs associated with TRPs of the set of TRPs.

The communication manager 1208 may separate a first RS from a second RS based at least in part on the first RS being associated with a first time-domain rotation coefficient and the second RS being associated with a second time-domain rotation wherein the first RS is associated with a first TRP and the second RS is associated with a second TRP.

The communication manager 1208 may apply a first time-domain rotation coefficient to the set of RSs.

The communication manager 1208 may identify a first Doppler spectrum associated with the first time-domain rotation coefficient.

The communication manager 1208 may identify, based at least in part on application of the first time-domain rotation coefficient, a first frequency value with a highest received power in the first Doppler spectrum.

The communication manager 1208 may apply a second time-domain rotation coefficient to the set of RSs.

The communication manager 1208 may identify a second Doppler spectrum associated with the second time-domain rotation coefficient.

The communication manager 1208 may identify, based at least in part on application of the first time-domain rotation coefficient, a second frequency value with a highest received power in the second Doppler spectrum wherein the indication of the Doppler frequencies associated with the TRPs of the set of TRPs includes an indication of the first frequency value associated with the first time-domain rotation coefficient and an indication of the second frequency value associated with the second time-domain rotation coefficient.

The communication manager 1208 may apply a first time-domain rotation coefficient to the set of RSs.

The communication manager 1208 may identify a first Doppler spectrum associated with the first time-domain rotation coefficient.

The communication manager 1208 may shift the first Doppler spectrum by an amount associated with the first time-domain rotation coefficient.

The communication manager 1208 may obtain a first time-domain signal associated with the first Doppler spectrum.

The communication manager 1208 may identify a first estimated Doppler frequency based at least in part on a slope of phases of the first time-domain signal.

The communication manager 1208 may apply a second time-domain rotation coefficient to the set of RSs.

The communication manager 1208 may identify a second Doppler spectrum associated with the second time-domain rotation coefficient.

The communication manager 1208 may shift the second Doppler spectrum by an amount associated with the second time-domain rotation coefficient.

The communication manager 1208 may obtain a second time-domain signal associated with the second Doppler spectrum.

The communication manager 1208 may identify a second estimated Doppler frequency based at least in part on a slope of phases of the second time-domain signal wherein the indication of the Doppler frequencies associated with the TRPs of the set of TRPs includes an indication of the first estimated Doppler frequency associated with the first time-domain rotation coefficient and an indication of the second estimated Doppler frequency associated with the second time-domain rotation coefficient.

The transmission component 1204 may transmit an indication of support for receiving the set of RSs in overlapping time resources with the set of RSs having the set of time-domain rotation coefficients applied.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a network node, or a network node may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include a communication manager (e.g., the communication manager 150).

In some aspects, the apparatus 1300 may be configured to perform one or more operations described herein in connection with FIGS. 8-9. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the network node described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the network node described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the network node described in connection with FIG. 2. In some aspects, the transmission component 1304 may be co-located with the reception component 1302 in a transceiver.

The transmission component 1304 may transmit an indication of a set of time-domain rotation coefficients associated with a set of TRPs through which a UE communicates with the network node. The transmission component 1304 may transmit a set of RSs via the set of TRPs in overlapping time resources, the set of RSs having the set of time-domain rotation coefficients applied. The reception component 1302 may receive an indication of TDCPs associated with TRPs of the set of TRPs.

The communication manager 1308 may select the time-domain rotation coefficients based at least in part on a number of TRPs in the set of TRPs.

The reception component 1302 may receive an indication of support for receiving the set of RSs in overlapping time resources with the set of RSs having the set of time-domain rotation coefficients applied.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a UE, comprising: receiving an indication of a set of time-domain rotation coefficients associated with a set of transmission reception points (TRPs) through which the UE communicates with a network node; receiving a set of reference signals (RSs) from the set of TRPs in overlapping time resources, the set of RSs having the set of time-domain rotation coefficients applied; and transmitting an indication of TDCPs associated with TRPs of the set of TRPs.

Aspect 2: The method of Aspect 1, further comprising: separating a first RS from a second RS based at least in part on the first RS being associated with a first time-domain rotation coefficient and the second RS being associated with a second time-domain rotation, wherein the first RS is associated with a first TRP and the second RS is associated with a second TRP.

Aspect 3: The method of any of Aspects 1-2, wherein a first time-domain rotation coefficient, of the set of time-domain rotation coefficients, is associated with a first TRP, of the set of TRPs, based at least in part on the first time-domain rotation coefficient and the first TRP being associated with a first control resource set (CORESET) pool index, and wherein a second time-domain rotation coefficient, of the set of time-domain rotation coefficients, is associated with a second TRP, of the set of TRPs, based at least in part on the second time-domain rotation coefficient and the second TRP being associated with a second CORESET pool index.

Aspect 4: The method of any of Aspects 1-3, wherein transmitting the indication of TDCPs comprises: transmitting a first indication of a first TDCP associated with a first rotation coefficient; and transmitting a second indication of a second TDCP associated with a second rotation coefficient.

Aspect 5: The method of any of Aspects 1-4, further comprising: applying a first time-domain rotation coefficient to the set of RSs; identifying a first Doppler spectrum associated with the first time-domain rotation coefficient; identifying, based at least in part on application of the first time-domain rotation coefficient, a first frequency value with a highest received power in the first Doppler spectrum; applying a second time-domain rotation coefficient to the set of RSs; identifying a second Doppler spectrum associated with the second time-domain rotation coefficient; and identifying, based at least in part on application of the first time-domain rotation coefficient, a second frequency value with a highest received power in the second Doppler spectrum, wherein the indication of the Doppler frequencies associated with the TRPs of the set of TRPs includes an indication of the first frequency value associated with the first time-domain rotation coefficient and an indication of the second frequency value associated with the second time-domain rotation coefficient.

Aspect 6: The method of any of Aspects 1-4, further comprising: applying a first time-domain rotation coefficient to the set of RSs; identifying a first Doppler spectrum associated with the first time-domain rotation coefficient; shifting the first Doppler spectrum by an amount associated with the first time-domain rotation coefficient; obtaining a first time-domain signal associated with the first Doppler spectrum; identifying a first estimated Doppler frequency based at least in part on a slope of phases of the first time-domain signal; applying a second time-domain rotation coefficient to the set of RSs; identifying a second Doppler spectrum associated with the second time-domain rotation coefficient; shifting the second Doppler spectrum by an amount associated with the second time-domain rotation coefficient; obtaining a second time-domain signal associated with the second Doppler spectrum; and identifying a second estimated Doppler frequency based at least in part on a slope of phases of the second time-domain signal, wherein the indication of the Doppler frequencies associated with the TRPs of the set of TRPs includes an indication of the first estimated Doppler frequency associated with the first time-domain rotation coefficient and an indication of the second estimated Doppler frequency associated with the second time-domain rotation coefficient.

Aspect 7: The method of any of Aspects 1-6, wherein the set of time-domain rotation coefficients comprise: a set of time-domain multiplicative factors or a set of time-domain phase shift additive factors.

Aspect 8: The method of any of Aspects 1-7, wherein the overlapping time resources comprise one or more of an RS time occasion or a time-domain symbol, and wherein receiving the set of RSs comprises receiving multiple RSs within a single RS time occasion or within a single time-domain symbol.

Aspect 9: The method of any of Aspects 1-8, wherein a time-domain rotation coefficient of the set of time-domain rotation coefficients has a value of one.

Aspect 10: The method of any of Aspects 1-9, further comprising: transmitting an indication of support for receiving the set of RSs in overlapping time resources with the set of RSs having the set of time-domain rotation coefficients applied.

Aspect 11: The method of any of Aspects 1-10, wherein the set of RSs comprises a set of tracking RSs (TRSs) or a set of channel status information RSs (CSI-RSs).

Aspect 12: The method of any of Aspects 1-11, wherein the TDCPs are associated with one or more of: a Doppler frequency, a Doppler spectrum, a time domain correlation coefficient, or a set of time-domain correlation coefficients.

Aspect 13: A method of wireless communication performed by a network node, comprising: transmitting an indication of a set of time-domain rotation coefficients associated with a set of transmission reception points (TRPs) through which a user equipment (UE) communicates with the network node; transmitting a set of reference signals (RSs) via the set of TRPs in overlapping time resources, the set of RSs having the set of time-domain rotation coefficients applied; and receiving an indication of TDCPs associated with TRPs of the set of TRPs.

Aspect 14: The method of Aspect 13, further comprising: selecting the time-domain rotation coefficients based at least in part on a number of TRPs in the set of TRPs.

Aspect 15: The method of any of Aspects 13-14, wherein a first time-domain rotation coefficient, of the set of time-domain rotation coefficients, is associated with a first TRP, of the set of TRPs, based at least in part on the first time-domain rotation coefficient and the first TRP being associated with a first control resource set (CORESET) pool index, and wherein a second time-domain rotation coefficient, of the set of time-domain rotation coefficients, is associated with a second TRP, of the set of TRPs, based at least in part on the second time-domain rotation coefficient and the second TRP being associated with a second CORESET pool index.

Aspect 16: The method of any of Aspects 13-15, wherein receiving the indication of TDCPs comprises: receiving a first indication of a first TDCP associated with a first rotation coefficient; and receiving a second indication of a second TDCP associated with a second rotation coefficient.

Aspect 17: The method of any of Aspects 13-16, wherein the set of time-domain rotation coefficients comprise: a set of time-domain multiplicative factors or a set of time-domain phase shift additive factors.

Aspect 18: The method of any of Aspects 13-17, wherein the overlapping time resources comprise one or more of an RS time occasion or a time-domain symbol, and wherein transmitting the set of RSs comprises transmitting multiple RSs within a single RS time occasion or within a single time-domain symbol.

Aspect 19: The method of any of Aspects 13-18, wherein a time-domain rotation coefficient of the set of time-domain rotation coefficients has a value of one.

Aspect 20: The method of any of Aspects 13-19, further comprising: receiving an indication of support for receiving the set of RSs in overlapping time resources with the set of RSs having the set of time-domain rotation coefficients applied.

Aspect 21: The method of any of Aspects 13-20, wherein the set of RSs comprises a set of tracking RSs (TRSs) or a set of channel status information RSs (CSI-RSs).

Aspect 22: The method of any of Aspects 13-21, wherein the TDCPs are associated with one or more of: a Doppler frequency, a Doppler spectrum, a time domain correlation coefficient, or a set of time-domain correlation coefficients.

Aspect 23: An apparatus for wireless communication at a device, comprising a processor; memory coupled with the processor; and instructions stored in the memory and executable by the processor to cause the apparatus to perform the method of one or more of Aspects 1-22.

Aspect 24: A device for wireless communication, comprising a memory and one or more processors coupled to the memory, the one or more processors configured to perform the method of one or more of Aspects 1-22.

Aspect 25: An apparatus for wireless communication, comprising at least one means for performing the method of one or more of Aspects 1-22.

Aspect 26: A non-transitory computer-readable medium storing code for wireless communication, the code comprising instructions executable by a processor to perform the method of one or more of Aspects 1-22.

Aspect 27: A non-transitory computer-readable medium storing a set of instructions for wireless communication, the set of instructions comprising one or more instructions that, when executed by one or more processors of a device, cause the device to perform the method of one or more of Aspects 1-22.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
a memory; and
one or more processors, coupled to the memory, configured to:
receive an indication of a set of time-domain rotation coefficients associated with a set of transmission reception points (TRPs) through which the UE communicates with a network node;
receive a set of reference signals (RSs) from the set of TRPs in overlapping time resources, the set of RSs having the set of time-domain rotation coefficients applied; and
transmit an indication of time-domain channel properties (TDCPs) associated with TRPs of the set of TRPs.

2. The UE of claim 1, wherein the one or more processors are further configured to:
separate a first RS from a second RS based at least in part on the first RS being associated with a first time-domain rotation coefficient and the second RS being associated with a second time-domain rotation,
wherein the first RS is associated with a first TRP and the second RS is associated with a second TRP.

3. The UE of claim 1, wherein a first time-domain rotation coefficient, of the set of time-domain rotation coefficients, is associated with a first TRP, of the set of TRPs, based at least in part on the first time-domain rotation coefficient and the first TRP being associated with a first control resource set (CORESET) pool index, and
wherein a second time-domain rotation coefficient, of the set of time-domain rotation coefficients, is associated with a second TRP, of the set of TRPs, based at least in part on the second time-domain rotation coefficient and the second TRP being associated with a second CORESET pool index.

4. The UE of claim 1, wherein the one or more processors, to transmit the indication of TDCPs, are configured to:
transmit a first indication of a first TDCP associated with a first rotation coefficient; and
transmit a second indication of a second TDCP associated with a second rotation coefficient.

5. The UE of claim 1, wherein the one or more processors are further configured to:
apply a first time-domain rotation coefficient to the set of RSs;
identify a first Doppler spectrum associated with the first time-domain rotation coefficient;
identify, based at least in part on application of the first time-domain rotation coefficient, a first frequency value with a highest received power in the first Doppler spectrum;
apply a second time-domain rotation coefficient to the set of RSs;
identify a second Doppler spectrum associated with the second time-domain rotation coefficient; and
identify, based at least in part on application of the first time-domain rotation coefficient, a second frequency value with a highest received power in the second Doppler spectrum,
wherein the indication of the TDCPs associated with the TRPs of the set of TRPs includes an indication of the first Doppler frequency value associated with the first time-domain rotation coefficient and an indication of the second Doppler frequency value associated with the second time-domain rotation coefficient.

6. The UE of claim 1, wherein the one or more processors are further configured to:
apply a first time-domain rotation coefficient to the set of RSs;
identify a first Doppler spectrum associated with the first time-domain rotation coefficient;
shift the first Doppler spectrum by an amount associated with the first time-domain rotation coefficient;
obtain a first time-domain signal associated with the first Doppler spectrum;
identify a first estimated Doppler frequency based at least in part on a slope of phases of the first time-domain signal;
apply a second time-domain rotation coefficient to the set of RSs;
identify a second Doppler spectrum associated with the second time-domain rotation coefficient;
shift the second Doppler spectrum by an amount associated with the second time-domain rotation coefficient;
obtain a second time-domain signal associated with the second Doppler spectrum; and
identify a second estimated Doppler frequency based at least in part on a slope of phases of the second time-domain signal,
wherein the indication of the TDCPs associated with the TRPs of the set of TRPs includes an indication of the first estimated Doppler frequency associated with the first time-domain rotation coefficient and an indication of the second estimated Doppler frequency associated with the second time-domain rotation coefficient.

7. (canceled)

8. The UE of claim 1, wherein the overlapping time resources comprise one or more of a TRS time occasion or a time-domain symbol, and
wherein the one or more processors, to receive the set of RSs, are configured to receive multiple RSs within a single RS time occasion or within a single time-domain symbol.

9. (canceled)

10. The UE of claim 1, wherein the one or more processors are further configured to:
transmit an indication of support for receiving the set of RSs in overlapping time resources with the set of RSs having the set of time-domain rotation coefficients applied.

11. (canceled)

12. (canceled)

13. A network node for wireless communication, comprising:
a memory; and
one or more processors, coupled to the memory, configured to:
transmit an indication of a set of time-domain rotation coefficients associated with a set of transmission reception points (TRPs) through which a user equipment (UE) communicates with the network node;
transmit a set of reference signals (RSs) via the set of TRPs in overlapping time resources, the set of RSs having the set of time-domain rotation coefficients applied; and
receive an indication of time-domain channel properties (TDCPs) associated with TRPs of the set of TRPs.

14. The network node of claim 13, wherein the one or more processors are further configured to:
select the time-domain rotation coefficients based at least in part on a number of TRPs in the set of TRPs.

15. The network node of claim 13, wherein a first time-domain rotation coefficient, of the set of time-domain rotation coefficients, is associated with a first TRP, of the set of TRPs, based at least in part on the first time-domain rotation coefficient and the first TRP being associated with a first control resource set (CORESET) pool index, and
wherein a second time-domain rotation coefficient, of the set of time-domain rotation coefficients, is associated with a second TRP, of the set of TRPs, based at least in part on the second time-domain rotation coefficient and the second TRP being associated with a second CORESET pool index.

16. The network node of claim 13, wherein the one or more processors, to receive the indication of TDCPs, are configured to:
receive a first indication of a first TDCP associated with a first rotation coefficient; and
receive a second indication of a second TDCP associated with a second rotation coefficient.

17. The network node of claim 13, wherein the set of time-domain rotation coefficients comprise:
a set of time-domain multiplicative factors or a set of time-domain phase shift additive factors.

18. The network node of claim 13, wherein the overlapping time resources comprise one or more of a RS time occasion or a time-domain symbol, and
wherein the one or more processors, to transmit the set of RSs, are configured to transmit multiple RSs within a single RS time occasion or within a single time-domain symbol.

19. (canceled)

20. The network node of claim 13, wherein the one or more processors are further configured to:
receive an indication of support for receiving the set of RSs in overlapping time resources with the set of RSs having the set of time-domain rotation coefficients applied.

21. (canceled)

22. The network node of claim 13, wherein the TDCPs are associated with one or more of:
a Doppler frequency,
a Doppler spectrum,
a time domain correlation coefficient, or
a set of time-domain correlation coefficients.

23. A method of wireless communication performed by a user equipment (UE), comprising:
receiving an indication of a set of time-domain rotation coefficients associated with a set of transmission reception points (TRPs) through which the UE communicates with a network node;
receiving a set of reference signals (RSs) from the set of TRPs in overlapping time resources, the set of RSs having the set of time-domain rotation coefficients applied; and
transmitting an indication of time-domain channel properties (TDCPs) associated with TRPs of the set of TRPs.

24. The method of claim 23, further comprising:
separating a first RS from a second RS based at least in part on the first RS being associated with a first time-domain rotation coefficient and the second RS being associated with a second time-domain rotation,
wherein the first RS is associated with a first TRP and the second RS is associated with a second TRP.

25. The method of claim 23, further comprising:
applying a first time-domain rotation coefficient to the set of RSs;
identifying a first Doppler spectrum associated with the first time-domain rotation coefficient;
identifying, based at least in part on application of the first time-domain rotation coefficient, a first frequency value with a highest received power in the first Doppler spectrum;
applying a second time-domain rotation coefficient to the set of RSs;
identifying a second Doppler spectrum associated with the second time-domain rotation coefficient; and
identifying, based at least in part on application of the first time-domain rotation coefficient, a second frequency value with a highest received power in the second Doppler spectrum,
wherein the indication of the Doppler frequencies associated with the TRPs of the set of TRPs includes an indication of the first frequency value associated with the first time-domain rotation coefficient and an indication of the second frequency value associated with the second time-domain rotation coefficient.

26. The method of claim 23, further comprising:
applying a first time-domain rotation coefficient to the set of RSs;
identifying a first Doppler spectrum associated with the first time-domain rotation coefficient;
shifting the first Doppler spectrum by an amount associated with the first time-domain rotation coefficient;
obtaining a first time-domain signal associated with the first Doppler spectrum;
identifying a first estimated Doppler frequency based at least in part on a slope of phases of the first time-domain signal;
applying a second time-domain rotation coefficient to the set of RSs;
identifying a second Doppler spectrum associated with the second time-domain rotation coefficient;
shifting the second Doppler spectrum by an amount associated with the second time-domain rotation coefficient;
obtaining a second time-domain signal associated with the second Doppler spectrum; and
identifying a second estimated Doppler frequency based at least in part on a slope of phases of the second time-domain signal,
wherein the indication of the Doppler frequencies associated with the TRPs of the set of TRPs includes an indication of the first estimated Doppler frequency associated with the first time-domain rotation coefficient and an indication of the second estimated Doppler frequency associated with the second time-domain rotation coefficient.

27.-30. (canceled)
